(19) United States
(12) Patent Application Publication
(10) Pub. No.: US 2018/0175365 A1
(43) Pub. Date: Jun. 21, 2018

(54) SECONDARY BATTERY ELECTRODE, AND SECONDARY BATTERY MANUFACTURING METHOD AND MANUFACTURING APPARATUS

(71) Applicant: NEC ENERGY DEVICES, LTD., Sagamihara-shi, Kanagawa (JP)

(72) Inventors: Takashi UEDA, Kanagawa (JP); Masanori HIRAI, Kanagawa (JP)

(73) Assignee: NEC ENERGY DEVICES, LTD., Sagamihara-shi, Kanagawa (JP)

(21) Appl. No.: 15/571,092

(22) PCT Filed: May 20, 2016
(86) PCT No.: PCT/JP2016/065076

§ 371 Date: Nov. 1, 2017

(30) Foreign Application Priority Data
May 20, 2015 (JP) 2015-102506

(51) Int. Cl. H01M 4/04; H01M 4/1391

(52) U.S. Cl. CPC H01M 4/0404; H01M 4/1391

(57) ABSTRACT

A method of manufacturing a secondary battery electrode having a coated portion at which an active material layer is formed, comprises a step of forming the coated portion which comprises a step of forming a thin portion of the active material layer which has a small thickness by discharging slurry containing an active material at a position where the die head is located close to the current collector, and a step of forming a thick portion of the active material layer which has a large thickness by discharging the slurry at a discharge pressure P2 larger than that in the step of forming the thin portion at a position where the die head is farther away from the current collector as compared with the step of forming the thin portion. The discharge pressure is changed in accordance with change of an interval between the die head and the current collector at a transition time between the step of forming the thin portion and the step of forming the thick portion.

### TECHNICAL FIELD

The present invention relates to a secondary battery electrode and secondary battery manufacturing method and manufacturing apparatus.

### BACKGROUND ART

Secondary batteries are widely pervasive as power supplies for portable equipment such as a cellular telephone, a digital camera, a laptop computer, etc., as well as power supplies for vehicles and household power supplies. Most specially, lithium ion secondary batteries which have high energy density and light weight have become energy storage devices indispensable for daily life.

Secondary batteries can be roughly classified into a wound type and a stacked type. A battery electrode assembly of a wound type secondary battery has a configuration in which an elongated positive electrode sheet and an elongated negative electrode sheet are overlap with each other with a separator interposed therebetween and are wound a plurality of times. A battery electrode assembly of a stacked type secondary battery has a configuration in which a plurality of positive electrode sheets and a plurality of negative electrode sheets are alternately and repeatedly stacked while being separated by separators. Each positive electrode sheet and negative electrode sheet has a coated portion at which a current collector is coated with an active material (may be a mixture containing the active material, binder, a conductive material and the like), and an uncoated portion at which no active material is coated because of the connection of an electrode terminal.

In both the wound type secondary battery and the stacked type secondary battery, the battery electrode assembly is contained and sealed in an outer container (outer case) such that one end of the positive electrode terminal is electrically connected to the uncoated portion of the positive electrode sheet and the other end thereof is drawn out to the outside of the outer container (outer case) while one end of the negative electrode terminal is electrically connected to the uncoated portion of the negative electrode sheet and the other end thereof is drawn out to the outside of the outer container. Electrolyte as well as the battery electrode assembly is contained and sealed in the outer container. Secondary batteries tend to be large in capacity year by year, and in connection with this tendency, a safety countermeasure against batteries is becoming increasingly important because heat generation in case of the occurrence of a short circuit becomes larger and increases risks.

As an example of the safety countermeasure, there is a configuration in which an insulating member is formed at a boundary portion between a coated portion and an uncoated portion in order to prevent a short circuit between a positive electrode and a negative electrode. However, when a portion of the battery electrode assembly is thickened due to formation of, for example, an insulating member having an elongated tape shape, there is a risk that battery quality will deteriorate, such as decrease of the energy density per unit volume, variation in electric characteristics due to failure to uniformly apply pressure to the battery electrode assembly, deterioration of cycle characteristics and the like.

In view of this, Patent Documents 1 and 2 disclose that the end portion of an active material layer is formed partially thinly, and an insulating member is disposed so as to straddle a thin portion and an uncoated portion, whereby the battery electrode assembly is prevented from being partially thickened due to the insulating member to thereby prevent or reduce deterioration of battery quality.

Patent Documents 1 and 2 adopt a configuration in which in order to form a portion of an active material layer that is thin, a shim is disposed in a discharge port of a die head to discharge active material onto a current collector so as to generate a portion at which the discharge thickness of the active material from the discharge port is small, thereby enabling simultaneous formation of a thick portion and a thin portion.

### PRIOR ART DOCUMENTS

### Patent Documents

Patent Document 1: International Publication No. WO2013/187172

Patent Document 2: International Publication No. WO2013/137385

### SUMMARY OF THE INVENTION

### Problem to be Solved by the Invention

In the case of executing so-called continuous coating in which, in order to form a large number of electrodes, an active material is discharged from a die head to an elongated sheet-like current collector that moves relative to the die head at a position facing the die head, thereby continuously and simultaneously forming a thin portion, a thick portion and an uncoated portion, a die head that has a shim disposed in a discharge port as shown in Patent Documents 1 and 2 can be used. However, in the case of executing so-called intermittent coating in which an uncoated portion, a thin portion and a thick portion of the active material are sequentially and repeatedly formed along the relative movement direction of the current collector, thin portions must be formed, not by using the shim, but by controlling the discharge amount of the active material from the die head. This control is very complicated, and it is not easy to accurately form a thin portion having the desired thickness.

Therefore, an object of the present invention is to solve the above-mentioned problem and provide a secondary battery electrode and secondary battery manufacturing method and manufacturing apparatus that can easily and precisely form a thin portion in a process for sequentially forming the thin portion and a thick portion of an active material along the direction of relative movement of the current collector that moves relative to the die head.

### Means to Solve the Problem

A method of manufacturing a secondary battery electrode having a coated portion at which an active material layer is formed on a current collector according to the present invention, comprises a step of forming the coated portion which comprises a step of forming a thin portion of the active material layer which has a small thickness by discharging slurry containing an active material from a die head at a position where the die head is located close to the current collector, and a step of forming a thick portion of the active material layer which has a large thickness by discharging the slurry from the die head at a discharge pressure larger than that in the step of forming the thin portion at a position where the die head is farther away from the current collector as compared with the step of forming the thin portion. The discharge pressure is changed in accordance with change of an interval between the die head and the current collector at a transition time between the step of forming the thin portion and the step of forming the thick portion.

Another method of manufacturing a secondary battery electrode having a coated portion at which an active material layer is formed on a current collector according to the present invention, comprises a step of forming the coated portion which comprises a steps of forming a thin portion of the active material layer which has a small thickness by discharging slurry containing an active material from a die head at a position where the die head is located close to the current collector, and a step of forming a thick portion of the active material layer which has a large thickness by discharging the slurry which is supplied to the die head at a flow rate larger than that in the step of forming the thin portion, from the die head, at a position where the die head is farther away from the current collector as compared with the step of forming the thin portion. The flow rate is changed in accordance with change of an interval between the die head and the current collector at a transition time between the step of forming the thin portion and the step of forming the thick portion.

An apparatus for manufacturing a secondary battery electrode having a coated portion at which an active material layer is formed on a current collector according to the present invention, comprises: a die head that discharges slurry containing an active material to the current collector; relative moving means that relatively moves the current collector relative to the die head at a position facing the die head; die head moving means capable of causing the die head to be close to or away from the current collector that is relatively moved relative to the die head by the relative moving means; movement amount detection means that detects a displacement of the die head by the die head moving means; a pump that supplies the slurry to the die head; a coating valve interposed between the die head and the pump; and control means that controls the pump based on a detection result of the movement amount detection means so that the slurry is discharged from the die head at a small discharge pressure when the die head is located at a position close to the current collector, and the slurry is discharged from the die head at a large discharge pressure when the die head is located away from the current collector, or control means that controls the pump based on a detection result of the movement amount detection means so that the slurry is supplied to the die head at a small flow rate when the die head is located at a position close to the current collector, and the slurry is supplied to the die head at a large flow rate when the die head is located away from the current collector.

### Advantageous Effect of Invention

According to the present invention, it is possible to easily and precisely form a thin portion in a process for sequentially forming the thin portion and a thick portion of an active material along the direction of relative movement of the current collector that moves relative to the die head.

### BRIEF DESCRIPTION OF DRAWINGS

FIG. 1A is a plan view showing the basic configuration of a stacked type secondary battery manufactured by the present invention.

FIG. 1B is a cross-sectional view taken along A-A line of FIG. 1A.

FIG. 2A is an enlarged plan view showing a principal part of a positive electrode of the secondary battery shown in FIGS. 1A and 1B.

FIG. 2B is an enlarged cross-sectional view of FIG. 2A.

FIG. 3 is a plan view showing a manufacturing process of a positive electrode of the secondary battery according to the present invention.

FIG. 4 is a plan view showing a step subsequent to FIG. 3 of the manufacturing process of the positive electrode of the secondary battery according to the present invention.

FIG. 5A is a plan view showing a step subsequent to FIG. 4 of the manufacturing process of the positive electrode of the secondary battery according to the present invention.

FIG. 5B is a plan view showing the positive electrode manufactured by the step shown in FIG. 5A.

FIG. 6 is a plan view showing a manufacturing process of a negative electrode of a secondary battery according to the present invention.

FIG. 7A is a plan view showing a step subsequent to FIG. 6 of the manufacturing process of the negative electrode of the secondary battery according to the present invention.

FIG. 7B is a plan view showing the negative electrode manufactured by the step shown in FIG. 7A.

FIG. 8 is a schematic diagram showing an example of an apparatus used for intermittent coating of an active material.

FIG. 9 is a graph showing various conditions of the manufacturing process for the secondary battery electrode according to the present invention.

FIG. 10 is a graph showing various conditions of the manufacturing process of the secondary battery electrode according to another exemplary embodiment of the present invention.

### DESCRIPTION OF EXEMPLARY EMBODIMENTS

Exemplary embodiments will be described hereunder with reference to the drawings.

### [Configuration of Secondary Battery]

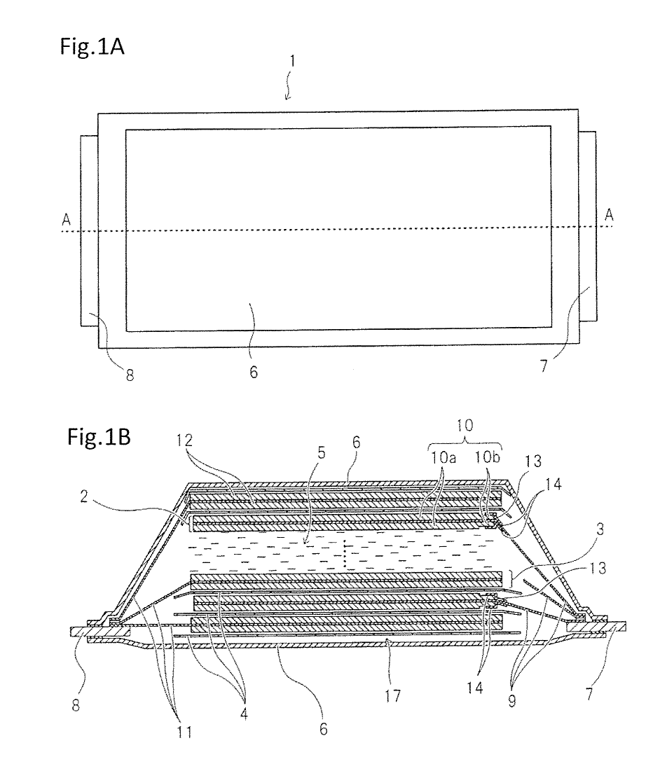

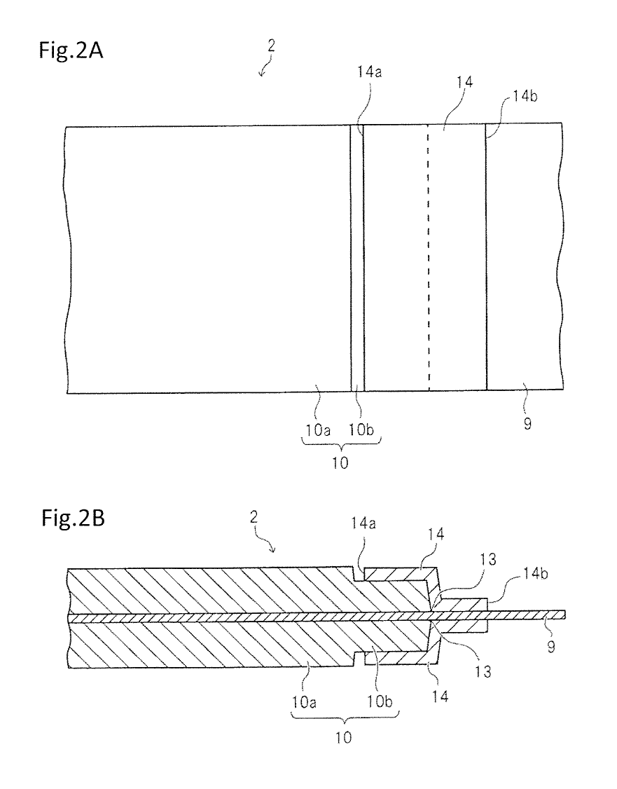

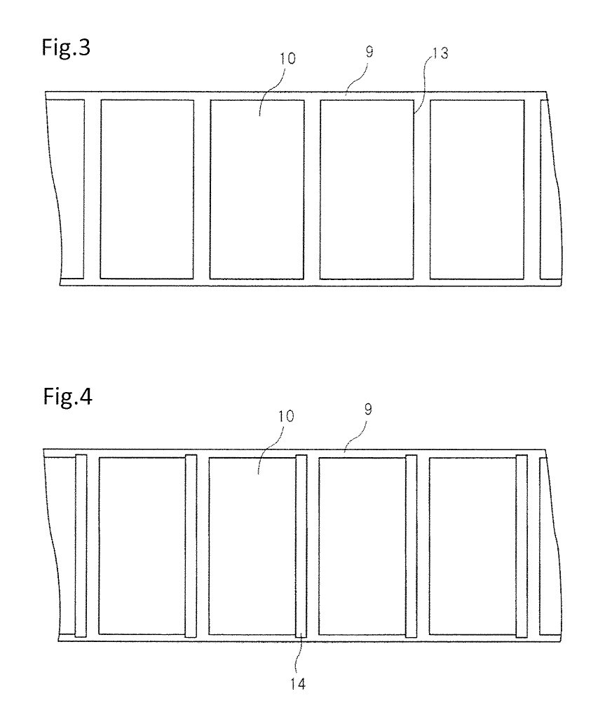

FIGS. 1A and 1B schematically show an example of the configuration of a stacked type lithium ion secondary battery manufactured by a manufacturing method according to the present invention. FIG. 1A is a plan view of the secondary battery which is viewed from an upper side in a direction perpendicular to a principal surface (flat surface) of the secondary battery, and FIG. 1B is a cross-sectional view taken along A-A line of FIG. 1A. FIG. 2A is an enlarged plan view of the principal part of a positive electrode, and FIG. 2B is an enlarged cross-sectional view of the principal part of the positive electrode.

Lithium ion secondary battery 1 according to the present invention includes electrode stacked body (battery electrode assembly) 17 in which positive electrodes (positive sheets) 2 and negative electrodes (negative sheets) 3 are alternately stacked in layers via separators 4. Electrode stacked body 17 is contained together with electrolyte 5 in an outer container comprised of flexible film 6. One end of positive electrode 7 is connected to positive electrode 2 of electrode stacked body 17, and one end of negative terminal 8 is connected to negative electrode 3. The other end side of positive electrode 7 and the other end side of negative electrode terminal 8 are drawn out to the outside of flexible film 6. In FIG. 1B, parts of the respective layers (layers located at an intermediate position in the thickness direction) of electrode stacked body 17 are omitted from illustration, and electrolyte 5 is shown there. In FIG. 1B, positive electrodes 2, negative electrodes 3 and separators 4 are shown to be in no contact with one another in order to visually clarify these elements. However, these elements are actually stacked in close contact with one another.

Positive electrode 2 includes current collector for positive electrode (positive electrode current collector) 9, and active material layer for positive electrode (positive electrode active material layer) 10 coated on positive electrode current collector 9. Coated portions at which positive electrode active material layer 10 is formed and uncoated portions at which positive electrode active material layer 10 is not formed are formed on both the front and back surfaces of positive electrode current collector 9 so as to be arranged side by side in the longitudinal direction. As shown in enlarged view in FIGS. 2A and 2B, positive electrode active material layers 10 on both surfaces of positive electrode current collector 9 of this exemplary embodiment each include thick portion 10a and thin portion 10b. Negative electrode 3 includes a current collector for the negative electrode (negative electrode current collector) 11 and an active material layer for the negative electrode (negative electrode active material layer) 12 coated on negative electrode current collector 11. Coated portions and uncoated portions are located side by side along the longitudinal direction on the front and back surfaces of negative electrode current collector 11.

The uncoated portion of each of positive electrode 2 and negative electrode 3 is used as a tab for connection with the electrode terminal (positive electrode terminal 7 or negative electrode terminal 8). The positive electrode tabs of positive electrodes 2 (positive electrode current collectors 9) are collected on positive electrode terminal 7, and connected to one another together with positive electrode terminal 7 by ultrasonic welding or the like. The negative tabs of negative electrodes 3 (negative current collectors 11) are collected on negative electrode terminal 8, and connected to one another together with negative electrode terminal 8 by ultrasonic welding or the like. In addition, the other end portion of positive electrode terminal 7 and the other end portion of negative electrode terminal 8 are respectively drawn out to the outside of the outer container comprised of flexible film 6.

As shown in FIGS. 2A and 2B, insulating member 14 for preventing a short-circuit with negative electrode terminal 8 is disposed so as to straddle thin portion 10b of the coated portion at which positive electrode active material layer 10 is formed and the uncoated portion at which positive electrode active material layer 10 is not formed and to cover boundary portion 13 (coincident with the termination position of positive electrode active material layer 10) between thin portion 10b of the coated portion and the uncoated portion. At the portion where insulting member 14 is located on thin portion 10b, the sum of the thickness of thin portion 10b and the thickness of insulating member 14 is smaller than the average thickness of thick portion 10a of positive electrode active material layer 10. Accordingly, since the portion of positive electrode 2 at which insulating member 14 is located is not thicker than the other portions, reduction of the energy density per volume can be prevented or reduced, and pressure can be uniformly applied to the battery electrode assembly to be fixed, so that deterioration of battery quality such as variation in electric characteristics, deterioration of cycle characteristics and the like can be prevented or reduced.

The outside dimension of the coated portion of negative electrode 3 (negative electrode active material layer 12) is larger than the outside dimension of the coated portion of positive electrode 2 (positive electrode active material layer 10), and equal to or smaller than the outside dimension of separator 4.

Negative electrode 3 of this exemplary embodiment includes negative electrode active material layers 12 having a uniform thickness which are formed on both surfaces of negative electrode current collector 11 and which do not have a thin portion, and is not provided with insulating member 14.

In the secondary battery of this exemplary embodiment, for example, layered oxide-based materials such as LiCoO₂, LiNiO₂, LiNi₍₁₋ₓ₎CoO₂, LiNiₓ(CoAl)₍₁₋ₓ₎O₂, Li₂MO₃-LiMO₂, and LiNi_{1/3}Co_{1/3}Mn_{1/3}O₂, spinel-based materials such as LiMn₂O₄, LiMn_{1.5}Ni_{0.5}O₄, and LiMn₍₂₋ₓ₎MₓO₄, olivine materials such as LiMPO₄, fluorinated olivine based materials such as Li₂MPO₄F and Li₂MSiO₄F, vanadium oxide based materials such as V₂O₅, and the like can be used as the material of positive electrode active material layer 10. One kind of these materials or a mixture of two or more kinds of these materials may be used.

Carbon materials such as graphite, amorphous carbon, diamond-like carbon, fullerene, carbon nanotube and carbon nanohorn, lithium metal materials, alloy type materials such as silicon and tin, oxide-based materials such as Nb₂O₅ and TiO₂, or composites thereof can be used as the material of negative electrode active material layer 12.

The active material mixture of positive electrode active material layer 10 and negative electrode material layer 12 is obtained by appropriately adding binder, conductive auxiliary agent or the like, to each of the active materials described above. One kind of or a combination of two or more of carbon black, carbon fiber, graphite and the like may be used as the conductive auxiliary agent. Polyvinylidene fluoride, polytetrafluoroethylene, carboxymethyl cellulose, modified acrylonitrile rubber particles, or the like may be used as the binder.

Aluminum, stainless steel, nickel, titanium, alloy of these materials or the like may be used for positive electrode current collector 9. Aluminum, in particular, is preferable. Copper, stainless steel, nickel, titanium, or an alloy thereof can be used for negative electrode current collector 11.

One kind or a mixture of two or more kinds of organic solvents such as a cyclic carbonate group containing ethylene carbonate, propylene carbonate, vinylene carbonate, butylene carbonate and the like, a chain carbonate group containing ethyl methyl carbonate (EMC), diethyl carbonate (DEC), dimethyl carbonate (DMC), dipropyl carbonate (DPC) and the like, an aliphatic carboxylic acid ester group, a γ-lactone group containing γ-butyrolactone and the like, a chain ether group, a cyclic ether group and the like may be used as electrolyte 5. Lithium salt may be dissolved in these organic solvents.

Separator 4 mainly includes a resinous porous film, a woven fabric, a nonwoven fabric or the like, and as a resin component thereof, for example, polyolefin resin such as polypropylene or polyethylene, polyester resin, acrylic resin, styrene resin, nylon resin or the like may be used. In particular, a polyolefin-based microporous film is preferable because it has excellent ion permeability qualities and also because its properties for physically isolating the positive electrode and the negative electrode from each other is excellent. Further, if necessary, a layer containing inorganic particles may be formed in separator 4. Insulating oxides, nitrides, sulfides, carbides and the like may be provided as the inorganic particles, and particularly TiO₂ or Al₂O₃ is preferably used as the inorganic particles.

A case which is formed of flexible film 6, a can case or the like may be used as the outer container, and a case formed of flexible film 6 is preferable from the viewpoint of reducing battery weight. A metal layer which is a base material having resin layers provided on the surface and back surfaces thereof may be used as flexible film 6. A material having barrier performance such as preventing leakage of electrolyte 5 and infiltration of moisture from the outside may be selected for the metal layer. Aluminum, stainless steel or the like may be used. A thermally fusible resin layer such as modified polyolefin is provided on at least one surface of the metal layer. The outer container is formed by making the thermally fusible resin layers of flexible film 6 face each other and thermally fusing the periphery of the portion in which electrolyte stacked body 17 is accommodated. A resin layer such as nylon film or polyester film may be provided to a surface of the outer container which is opposite to the surface on which the thermally fusible resin layer is formed.

Aluminum or aluminum alloy may be used for positive electrode terminal 7. Copper, copper alloy, nickel-plated copper, nickel-plated copper alloy or the like may be used for negative electrode terminal 8. The other end portion sides of respective terminals 7 and 8 are drawn out to the outside of the outer container. Thermally fusible resin may be provided beforehand to sites of respective terminals 7 and 8 which correspond to the portion to be thermally fused of the outer peripheral portion of the outer container.

Polyimide, glass fiber, polyester, polypropylene or a material containing the above materials may be used for insulating member 14 which is formed so as to cover boundary portion 13 between the coated portion and the uncoated portion of positive electrode active material layer 10. Insulating member 14 may be formed by applying heat to a resin member having an elongated tape shape so that resin member having an elongated tape shape is fused to boundary portion 13 or by coating gel-like resin on boundary portion 13 and then drying the gel-like resin.

The boundary portion between the coated portion and the uncoated portion of positive electrode 2 and negative electrode 3 and the end portions thereof may be configured not to have a linear shape perpendicular to the extension direction of current collectors 9 and 11, but to have a rounded curved shape. For example, unavoidable inclination, irregularities, roundness or the like of each layer caused by variations in the manufacturing process or layer forming ability may occur in both positive electrode active material layer 10 and negative electrode active material layer 12.

### [Secondary Battery Manufacturing Method]

When a secondary battery is manufactured, an electrode for the secondary battery is first manufactured. Specifically, as shown in FIG. 3, positive electrode active material layers 10 are formed on elongated belt-shaped positive electrode current collector 9 to manufacture a plurality of positive electrodes (positive electrode sheets) 2. This positive electrode active material layer 10 is intermittently formed on each of both surfaces of positive electrode current collector 9. Although it is difficult to understand in FIGS. 3 and 4, as described with reference to FIGS. 1A to 2B, positive electrode active material layer 10 includes thick portion 10a as a main portion and thin portion 10b which is provided continuously with one end portion of thick portion 10a. Details of the method of forming positive electrode active material layer 10 will be described later. The end portion of the coated portion (positive electrode active material layer 10) at boundary portion 13 between the coated portion and the uncoated portion may rise substantially perpendicularly to or inclined with respect to positive electrode current collector 9 as shown in FIG. 2B. The boundary portion between thin portion 10b and thick portion 10a may also be substantially perpendicular or inclined with respect to positive electrode current collector 9.

Next, as shown in FIG. 4, insulating member 14 is formed so as to cover boundary portion 13 between the coated portion (the portion where positive electrode active material layer 10 is formed) and the uncoated portion (the portion where positive electrode active material layer 10 is not formed). One end portion 14a of insulating member 14 is located on thin portion 2b of positive electrode active material layer 2, and the other end portion 14b is located on the uncoated portion. When the thickness of insulating member 14 is small, there is a risk that a sufficient insulating properties cannot be obtained, and thus the thickness is preferably equal to m or more. Furthermore, in order to achieve the effect of sufficiently reducing any increase in the thickness of electrode stacked body 17 according to the present invention, it is preferable that the thickness of insulting member 14 is smaller than the difference in thickness between thick portion 10a and thin portion 10b of positive electrode active material layer 10.

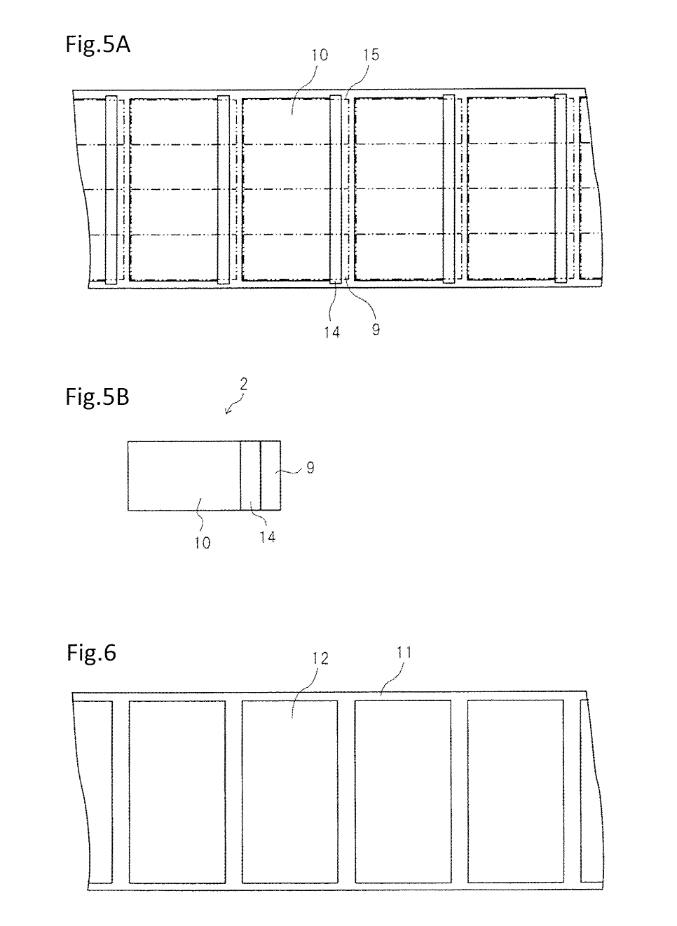

Thereafter, in order to realize positive electrode 2 so that it can be used for an individual stacked type battery, positive electrode current collector 9 is cut and divided along cutting line 15 represented by two dotted chain lines in FIG. 5A to fabricate positive electrodes 2 each having the desired size shown in FIG. 5B. Cutting lines 15 are virtual lines, and they are not actually formed.

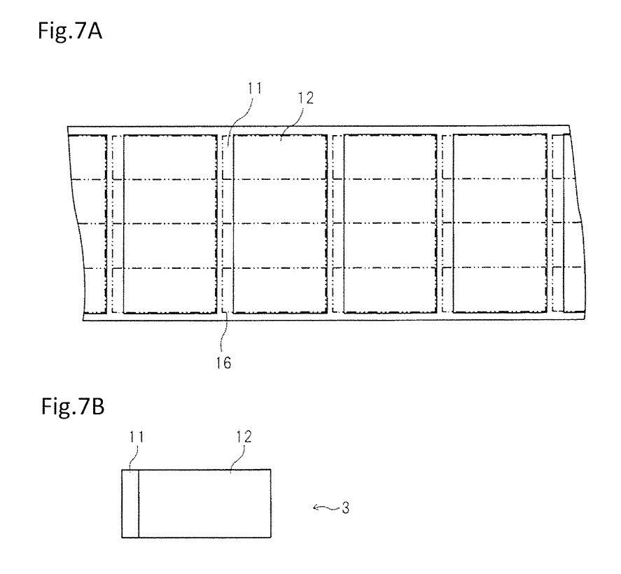

As shown in FIG. 6, negative electrode active material layer 12 is intermittently coated on both surfaces of negative current collector 11 whose area is large enough to manufacture a plurality of negative electrodes (negative sheets) 3. Negative electrode active material layer 12 has no thin portion, and has a fixed thickness. The end portion (the end portion of the coated portion) of the negative electrode active material layer 12 may be slightly inclined, or may rise substantially perpendicularly to negative electrode current collector 11. Thereafter, in order to fabricate negative electrode 3 to be used for an individual stacked type battery, negative electrode current collector 11 is cut and divided along a cutting line 16 represented by two-dotted chain lines in FIG. 7A to realize negative electrodes 3 so that they each have the desired size shown in FIG. 7B. Cutting lines 16 are virtual lines, and they are not actually formed.

Thus-formed positive electrodes 2 shown in FIG. 5B and negative electrodes 3 shown in FIG. 7B are alternately stacked with each separator 4 being interposed therebetween, and then positive electrode terminal 7 and negative electrode terminal 8 are connected to them, thereby forming electrode stacked body 17. This electrode stacked body 17 is contained and sealed together with electrolyte 5 in the outer container comprised of flexible film 6, thereby forming secondary battery 1 shown in FIGS. 1A and 1B.

According to secondary battery 1, the increase in the thickness caused by insulating member 14 formed so as to cover boundary portion 13 between the coated portion and the uncoated portion of positive electrode 2 is absorbed (offset) by thin portion 10b that is thinner than thick portion 10a of positive electrode active material layer 10, so that a portion of electrode stacked body 17 is prevented from becoming thicker than the other portions thereof.

Therefore, pressure can be uniformly applied to electrode stacked body 17 to hold electrode stacked body 17 so that quality deterioration such as variation in electric characteristics, deterioration in cycle characteristics and the like can be prevented or reduced. When the difference in thickness between thick portion 10a and thin portion 10b is larger than the thickness of insulating member 14, it is possible to prevent the thickness of a portion of electrode stacked body 17 from being increased by insulating member 14, and thus this is exceptionally effective.

However, even when the difference in thickness between thick portion 10a and thin portion 10b is smaller than the thickness of insulating member 14, it is possible to reduce a local increase in thickness of electrode stacked body 17 by providing thin portion 10b, and a certain degree of effect can be obtained.

In the example of FIG. 7B, the uncoated portion of negative electrode 3 is not present at the position facing the uncoated portion (positive electrode tab) of positive electrode 2, but the coated portion is terminated there. However, it is also possible to adopt a configuration in which the uncoated portion is present at the position facing the uncoated portion of positive electrode 2 on negative electrode 3. As shown in FIG. 7B, an uncoated portion serving as a negative electrode tab is provided at an end portion of negative electrode 3 which does not face the uncoated portion of positive electrode 2. The terminal positions of active material layers 10 and 12 (the planar position of the end portion of the coated portion) may be different or coincident on both surfaces of current collectors 9 and 11.

The thickness, the distance and the like of each member of the present invention mean the average values of measured values at arbitrary three or more places unless otherwise specified.

### [Detailed Method of Manufacturing Electrode]

A detailed method of manufacturing an electrode in the secondary battery manufacturing process according to the present invention described above will be described. The following description relates to an example of the method in which positive electrode 2 is manufactured, but negative electrode 3 may be also manufactured by the following method.

The method of forming the active material layer on the current collector in the present invention is an intermittent coating method in which a coated portion of an active material mixture and an uncoated portion are alternately and repetitively formed along the longitudinal direction of the elongated current collector by mainly using a die coater containing a die head.

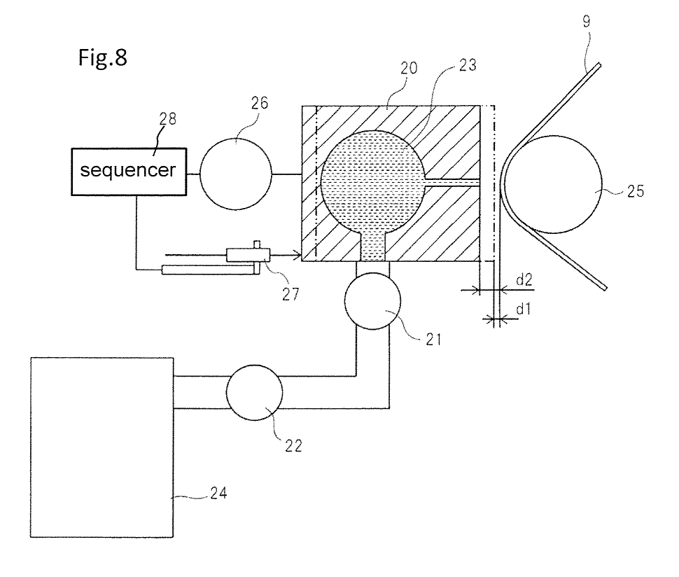

FIG. 8 is a diagram showing an example of the configuration of the die coater (manufacturing apparatus) for performing intermittent coating in the present invention. As shown in FIG. 8, the die coater for performing intermittent coating includes die head 20, coating valve 21 connected to die head 20, pump 22 and tank 24 for storing slurry 23 of an active material mixture. Relative moving means for relatively moving current collector 9 relative to die head 20 at a position facing die head 20 is disposed. In this exemplary embodiment, the current collector is wound up by a winding mechanism (not shown) which is an example of the relative moving means, and current collector 9 on which the active material layer is to be formed is transported along rotation of roller 25. Die head 20 is driven by servo motor 26 as die head moving means so as to be capable of being close to and away from roller 25, and the displacement (movement amount) of die head 20 is detected by movement amount detection means 27. Control means (sequencer) 28 controls the operation of servomotor 26 based on the detection result of movement amount detection means 27. This manufacturing apparatus may be provided with a return path for returning slurry from die head 20 to tank 24, and a return valve may be provided in the return path.

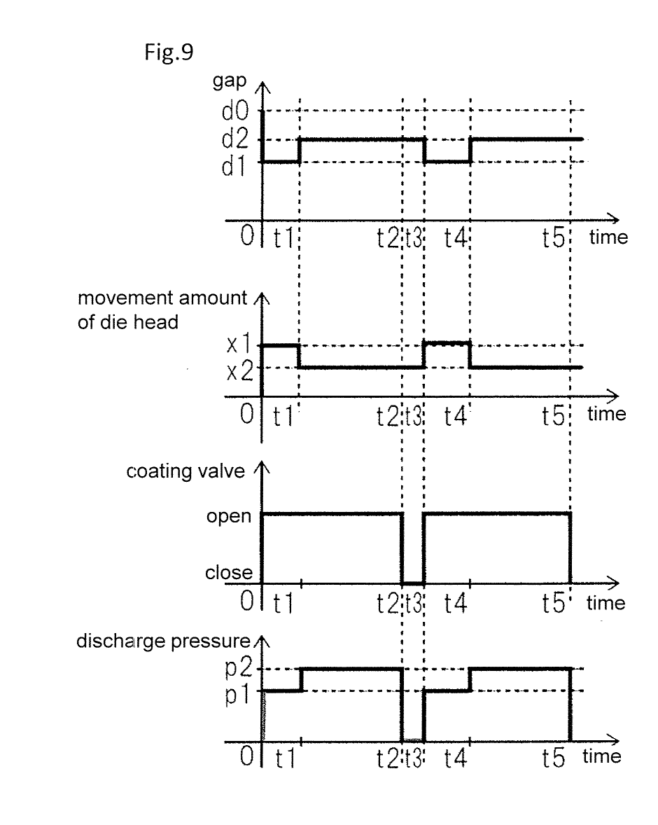

In the electrode manufacturing method using the die coater according to the present invention, as shown in FIG. 9, when the uncoated portion is formed, coating valve 21 is closed and current collector 9 is transported along the rotation of the roller 25 without discharging slurry from die head 20. Next, in order to form thin portion 10b of active material layer 10, die head 20 approaches roller 25 and current collector 9 (the displacement x1 of die head 20, the interval (gap) d1 between die head 20 and current collector 9), coating valve 21 is opened, and further pump 22 is adjusted to set a predetermined low pressure (discharge pressure p1). As a result, slurry 23 is discharged from die head 20 located at a position close to current collector 9 (represented by a two-dot chain line) at a low discharge pressure to form thin portion 10b.

When thin portion 10b having the desired size has been formed, the method is shifted to the formation of thick portion 10a. Specifically, when a time t1 which is required to form thin portion 10b having the desired size and which is calculated from the transport speed of current collector 9, the coating amount of slurry and the like, has elapsed from the start of the discharge of slurry 23, sequencer 28 activates servomotor 26 to move die head 20 away from roller 25 and current collector 9 (the displacement x2 of die head 20 and the interval d2 between die head 20 and current collector 9). At this time, coating valve 21 is kept open, and pump 22 is adjusted to set a predetermined pressure (discharge pressure p2). As a result, slurry 23 is discharged from die head 20 at a position far from current collector 9 (represented by a solid line) at a high discharge pressure to form thick portion 10b. Coating valve 21 is closed when a time (t2-t1) which is required to form thick portion 10a having the desired size and which is calculated from the transport speed of current collector 9, has elapsed from the time point t1 of the movement of die head 20 and the adjustment of pump 22. As a result, the method shifts to the formation of an uncoated portion.

At subsequent times t3 to t5, formation of an uncoated portion, formation of thin portion 10b and formation of thick portion 10a as described above are sequentially repeated to form many active material layers 10. Thereafter, current collector 9 is cut to obtain many electrodes 2.

It is preferable to preset conditions, such as the aforementioned times, the coating amount of slurry, the distance between the die head and the current collecting foil and the like, such that they are suitable for forming thick portion 10a as principal portions of active material layer 10 and thin portion. In the foregoing example, the interval d2 between die head 20 and current collector 9 when die head 20 is located away from current collector 9, the discharge pressure p2 at that time, the interval d1 when die head 20 is moved to be closer to current collector 9, and the discharge pressure p1 at that time, are preset such that these conditions are suitable for forming the thin portion 10b. Every time the intermittent coating is performed or for each predetermined number of times that the intermittent coating is performed, the film thickness, factors affecting the film thickness, such as the slurry viscosity, etc. may be sensed, and fed back to adjusting the time for coating the slurry, the discharge amount, and the distance between the die head and the current collecting foil.

As described above, according to the present invention, when thin portion 10b is formed, die head 20 is located closer to current collector 9, and the discharge pressure is smaller as compared with a case where thick portion 10a is formed. Accordingly, it is possible to accurately form thick portion 10a and thin portion 10b, and it is possible to prevent or reduce such a problem that thin portion 10b is locally thick at the transition portion to thick portion 10a, for example. In particular, in the case of a configuration in which pump 22 is controlled based on the detection result of the movement amount detection means 27 for detecting the movement of die head 20, the discharge pressure can be adjusted without any time lag in accordance with the movement of die head 20, so that thick portion 10a and thin portion 10b can be formed more accurately.

### Other Exemplary Embodiments

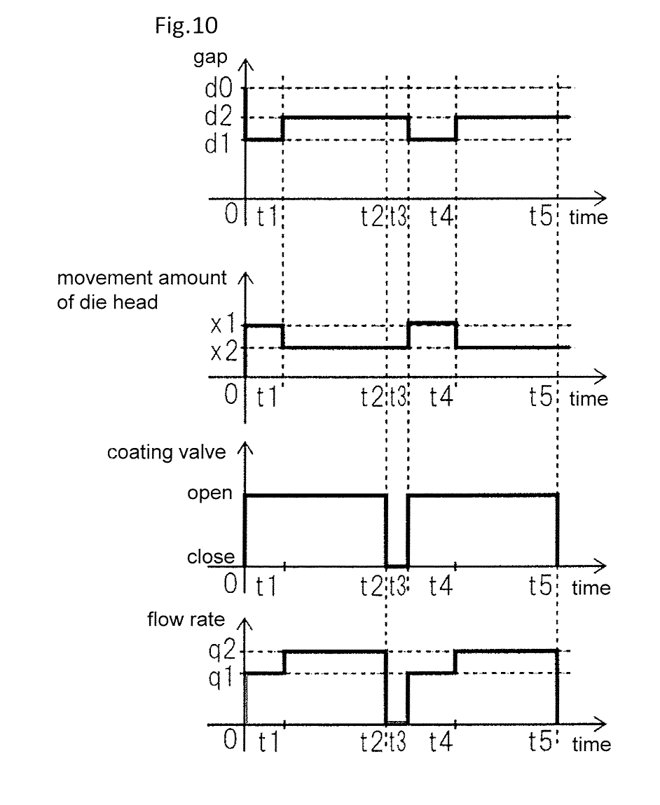

An electrode manufacturing method according to another exemplary embodiment of the present invention will be described with reference to FIG. 10.

In this exemplary embodiment, pump 22 is controlled in accordance with the movement of die head 20 to adjust the flow rate of slurry 23 to be supplied to die head 20. Specifically, as in the case of the foregoing exemplary embodiment, when the uncoated portion is formed, coating valve 21 is closed, and current collector 9 is transported by the rotation of roller 25 without discharging slurry 23 from die head 20. Next, in order to form thin portion 10b of active material layer 10, die head 20 is located closer to roller 25 and current collector 9 (the displacement x1 of die head 20, the interval d1 between die head 20 and current collector 9), coating valve 21 is opened and pump 22 is adjusted to set a predetermined flow rate q1, whereby slurry 23 is supplied at a small flow rate q1 to die head 20 located at a position (illustrated by a two-dotted chain line) close to current collector 9, and thus supplied slurry 23 is discharged from die head 20 to form thin portion 10b.

When the time t1 required to form thin portion 10b having the desired size has elapsed, sequence 28 actuates servo motor 26 to move die head 20 away from roller 25 and current collector 9 (the displacement x2 of die head 20, the interval d2 between die head 20 and current collector 9). At this time, coating valve 21 is kept open, and pump 22 is adjusted to set a predetermined flow rate q2, whereby slurry 23 is supplied at a large flow rate q2 to die head 20 located away from current collector 9 (represented by a solid line), and thus supplied slurry 23 is discharged from die head 20 to form thick portion 10b. When the time (t2-t1) required to form thick portion 10a having the desired size has elapsed, coating valve 21 is closed and the method shifts to the formation of an uncoated portion. As described above, formation of the uncoated portion, formation of thin portion 10b and formation of thick portion 10a are sequentially repeated to form many active material layers 10.

Thereafter, current collector 9 is cut to obtain many electrodes 2. Normally, conditions suitable for forming thick portion 10a are set in advance, that is, the interval d2 between die head 20 and current collector 9 when die head 20 is located away from current collector 9, and the flow rate q2 at that time are set in many cases, so that the interval d1 when die head 20 is located closer to current collector 9 and the flow rate q1 at that time may be newly set as a condition for forming thin portion 10b.

As described above, according to the present invention, in the case of forming thin portion 10b, die head 20 is located closer to current collector 9, and the flow rate of slurry 23 to be supplied to die head 20 is made smaller as compared with those in the case of formation of thick portion 10a. As a result, thick portion 10a and thin portion 10b can be formed with high accuracy, and trouble in which thin portion 10b becomes locally thicker at the transition portion to the thick portion 10a can be prevented or reduced. Particularly, in the case of a configuration in which pump 22 is controlled based on the detection result of moving amount detection means 27 for detecting movement of die head 20, the flow rate can be adjusted without any time lag in accordance with the movement of die head 20, so that thick portion 10a and thin portion 10b can be formed with high accuracy. The movement amount detection means described in the specification of the present application may be an encoder for detecting the movement amount based on the rotation of a shaft for moving the die head or a displacement sensor for measuring the movement itself of the die head, but it may not be limited to these elements.

The two exemplary embodiments described above are configured so that insulating member 14 is provided to only positive electrode 2, and no insulating member is provided to negative electrode 3, and is also configured so that positive electrode active material layer 10 comprises thick portion 10a and thin portion 10b while negative electrode active material layer 12 comprises only thick portion (having no thin portion). However, the exemplary embodiments may be configured so that only negative electrode 3 is provided with an insulating member while positive electrode 2 is not provided with insulating member 14, and positive electrode active material layer 10 comprises only thick portion 10a while negative electrode active material layer 12 comprises a thick portion and a thin portion. Furthermore, the exemplary embodiments may be configured so that each of positive electrode 2 and negative electrode 3 may be provided with an insulating member, and each of positive electrode active material layer 10 and negative electrode active material layer 12 has a thick portion and a thin portion. In any configuration, in the active material layer having the thick portion and the thin portion, the part of the insulating member is disposed on the thin portion, and at least a part of any thickness increase caused by the insulating member is adsorbed (offset) by the difference between the thick portion and the thin portion, thereby achieving the effect of preventing or reducing an increase in the thickness of the battery electrode assembly.

The present invention is useful for a lithium ion secondary battery and a method of manufacturing an electrode for the same, but it is also effectively applicable to secondary batteries other than a lithium ion secondary battery and a method of manufacturing electrodes for the same.

The present invention has been described by referring to some exemplary embodiments. However, the present invention is not limited to the configurations of the foregoing exemplary embodiments, and various modifications which those skilled in the art can understand can be made to the configuration and details of the present invention within the scope of the technical idea of the present invention.

The present application claims a priority based on Japanese Patent Application No. 2015-102506 filed on May 20, 2015, and the disclosure of which is incorporated herein in its entirety.

1. A method of manufacturing a secondary battery electrode having a coated portion at which an active material layer is formed on a current collector, comprising a step of forming the coated portion which comprises a step of forming a thin portion of the active material layer which has a small thickness by discharging slurry containing an active material from a die head at a position where the die head is located close to the current collector, and a step of forming a thick portion of the active material layer which has a large thickness by discharging the slurry from the die head at a discharge pressure larger than that in said step of forming the thin portion at a position where the die head is farther away from the current collector as compared with said step of forming the thin portion, wherein the discharge pressure is changed in accordance with change of an interval between the die head and the current collector at a transition time between said step of forming the thin portion and said step of forming the thick portion.

2. The method of manufacturing a secondary battery electrode according to claim 1, wherein the change of the interval between the die head and the current collector is performed by movement of the die head, the movement of the die head is detected by movement amount detection means, and a pump that supplies the slurry to the die head is controlled based on a detection result of the movement amount detection means to change the discharge pressure.

3. A method of manufacturing a secondary battery electrode having a coated portion at which an active material layer is formed on a current collector comprising a step of forming the coated portion which comprises a steps of forming a thin portion of the active material layer which has a small thickness by discharging slurry containing an active material from a die head at a position where the die head is located close to the current collector, and a step of forming a thick portion of the active material layer which has a large thickness by discharging the slurry which is supplied to the die head at a flow rate larger than that in said step of forming the thin portion, from the die head, at a position where the die head is farther away from the current collector as compared with said step of forming the thin portion, wherein the flow rate is changed in accordance with change of an interval between the die head and the current collector at a transition time between said step of forming the thin portion and said step of forming the thick portion.

4. The method of manufacturing a secondary battery electrode according to claim 3, wherein the change of the interval between the die head and the current collector is performed by movement of the die head, the movement of the die head is detected by movement amount detection means, and a pump that supplies the slurry to the die head is controlled based on a detection result of the movement amount detection means to change the flow rate.

5. The method of manufacturing a secondary battery electrode according to claim 1, further comprising a step of forming an uncoated portion at which the active material layer is not formed by relatively moving the current collector relative to the die head at a position facing the die head without discharging the slurry from the die head to the current collector, wherein said step of forming the uncoated portion, said step of forming the thin portion and said step of forming the thick portion are sequentially and repetitively performed.

6. The method of manufacturing a secondary battery electrode according to claim 5, further comprising a step of disposing an insulting member so that the insulating member straddles between the thin portion of the active material layer and the uncoated portion.

7. A method of manufacturing a secondary battery comprising the steps of forming positive electrode active material layers on both surfaces of a positive electrode current collector to form a positive electrode, forming negative electrode active material layers on both surfaces of a negative electrode current collector to form a negative electrode, and laminating the positive electrode and the negative electrode via a separator, wherein any one or both of said step of forming the positive electrode and said step of forming the negative electrode comprises said steps of the method of manufacturing a secondary battery electrode according to claim 1.

8. An apparatus for manufacturing a secondary battery electrode having a coated portion at which an active material layer is formed on a current collector, the apparatus comprising:
a die head that discharges slurry containing an active material to said current collector;
relative moving means that relatively moves said current collector relative to said die head at a position facing said die head;
die head moving means capable of causing said die head to be close to or away from said current collector that is relatively moved relative to the die head by said relative moving means;
movement amount detection means that detects a displacement of said die head by said die head moving means;
a pump that supplies the slurry to said die head;
a coating valve interposed between said die head and said pump; and
control means that controls said pump based on a detection result of said movement amount detection means so that the slurry is discharged from said die head at a small discharge pressure when said die head is located at a position close to said current collector, and the slurry is discharged from said die head at a large discharge pressure when said die head is located away from said current collector, or control means that controls said pump based on a detection result of said movement amount detection means so that the slurry is supplied to said die head at a small flow rate when said die head is located at a position close to said current collector, and the slurry is supplied to said die head at a large flow rate when said die head is located away from said current collector.

9. (canceled)

10. The method of manufacturing a secondary battery electrode according to claim 2, further comprising a step of forming an uncoated portion at which the active material layer is not formed by relatively moving the current collector relative to the die head at a position facing the die head without discharging the slurry from the die head to the current collector, wherein said step of forming the uncoated portion, said step of forming the thin portion and said step of forming the thick portion are sequentially and repetitively performed.

11. The method of manufacturing a secondary battery electrode according to claim 10, further comprising a step of disposing an insulting member so that the insulating member straddles between the thin portion of the active material layer and the uncoated portion.

12. A method of manufacturing a secondary battery comprising the steps of forming positive electrode active material layers on both surfaces of a positive electrode current collector to form a positive electrode, forming negative electrode active material layers on both surfaces of a negative electrode current collector to form a negative electrode, and laminating the positive electrode and the negative electrode via a separator, wherein any one or both of said step of forming the positive electrode and said step of forming the negative electrode comprises said steps of the method of manufacturing a secondary battery electrode according to claim 2.

13. The method of manufacturing a secondary battery electrode according to claim 3, further comprising a step of forming an uncoated portion at which the active material layer is not formed by relatively moving the current collector relative to the die head at a position facing the die head without discharging the slurry from the die head to the current collector, wherein said step of forming the uncoated portion, said step of forming the thin portion and said step of forming the thick portion are sequentially and repetitively performed.

14. The method of manufacturing a secondary battery electrode according to claim 13, further comprising a step of disposing an insulting member so that the insulating member straddles between the thin portion of the active material layer and the uncoated portion.

15. A method of manufacturing a secondary battery comprising the steps of forming positive electrode active material layers on both surfaces of a positive electrode current collector to form a positive electrode, forming negative electrode active material layers on both surfaces of a negative electrode current collector to form a negative electrode, and laminating the positive electrode and the negative electrode via a separator, wherein any one or both of said step of forming the positive electrode and said step of forming the negative electrode comprises said steps of the method of manufacturing a secondary battery electrode according to claim 3.

16. The method of manufacturing a secondary battery electrode according to claim 4, further comprising a step of forming an uncoated portion at which the active material layer is not formed by relatively moving the current collector relative to the die head at a position facing the die head without discharging the slurry from the die head to the current collector, wherein said step of forming the uncoated portion, said step of forming the thin portion and said step of forming the thick portion are sequentially and repetitively performed.

17. The method of manufacturing a secondary battery electrode according to claim 16, further comprising a step of disposing an insulting member so that the insulating member straddles between the thin portion of the active material layer and the uncoated portion.

18. A method of manufacturing a secondary battery comprising the steps of forming positive electrode active material layers on both surfaces of a positive electrode current collector to form a positive electrode, forming negative electrode active material layers on both surfaces of a negative electrode current collector to form a negative electrode, and laminating the positive electrode and the negative electrode via a separator, wherein any one or both of said step of forming the positive electrode and said step of forming the negative electrode comprises said steps of the method of manufacturing a secondary battery electrode according to claim 4.

19. A method of manufacturing a secondary battery comprising the steps of forming positive electrode active material layers on both surfaces of a positive electrode current collector to form a positive electrode, forming negative electrode active material layers on both surfaces of a negative electrode current collector to form a negative electrode, and laminating the positive electrode and the negative electrode via a separator, wherein any one or both of said step of forming the positive electrode and said step of forming the negative electrode comprises said steps of the method of manufacturing a secondary battery electrode according to claim 5.

20. A method of manufacturing a secondary battery comprising the steps of forming positive electrode active material layers on both surfaces of a positive electrode current collector to form a positive electrode, forming negative electrode active material layers on both surfaces of a negative electrode current collector to form a negative electrode, and laminating the positive electrode and the negative electrode via a separator, wherein any one or both of said step of forming the positive electrode and said step of forming the negative electrode comprises said steps of the method of manufacturing a secondary battery electrode according to claim 6.
